(19) United States
(12) Patent Application Publication
(10) Pub. No.: US 2026/0281566 A1
(43) Pub. Date: Sep. 17, 2026

(54) INFORMATION PROCESSING APPARATUS, IMAGE CAPTURING SYSTEM, AND METHOD

(71) Applicant: CANON KABUSHIKI KAISHA, Tokyo (JP)

(72) Inventor: AKIHIRO KATSUKI, Kanagawa (JP)

(21) Appl. No.: 19/555,086

(22) Filed: Mar. 3, 2026

(30) Foreign Application Priority Data
Mar. 13, 2025 (JP) 2025-040487

(51) Int. Cl. H04N 23/84; H04N 23/667

(52) U.S. Cl. CPC H04N 23/84; H04N 23/667

(57) ABSTRACT

An information processing apparatus records, based on whether at least a predetermined parameter is included in color adjustment information recorded independently from image capturing condition information, a color adjustment setting of the color adjustment information or reference information of the color adjustment information in the image capturing condition information.

### CROSS REFERENCE TO RELATED APPLICATON

This application claims the benefit of Japanese Patent Application No. 2025-040487, filed Mar. 13, 2025 which is hereby incorporated by reference herein in its entirety.

### BACKGROUND

### Field of the Technology

The present disclosure relates to an information processing apparatus, an image capturing system, and a method.

### Description of the Related Art

In the field of video production, image capturing systems that make it possible to edit and distribute moving images using an Internet Protocol (IP) network, such as the Internet, are becoming increasingly common in recent years. In a typical image capturing system, a moving image editing device (a switcher or the like) receives a video stream including a moving image, audio, and the like output from an image capturing apparatus (a digital video camera or the like) connected to an IP network. The video stream is delivered (output) after being edited into video for broadcast as necessary. The image capturing apparatus of the image capturing system is not limited to an image capturing apparatus used while being held by a user, and may be an image capturing apparatus on a gimbal for which pan, tilt, zoom, and the like are controlled by a user remotely.

In such an image capturing system, color adjustment information (also called a “custom picture file”) is registered in advance. In the color adjustment information, a plurality of color adjustment settings are associated with a 3D LUT file (also called a “Look file”), which is a collection of predetermined parameters. A function through which the user can then set a plurality of color adjustment settings and predetermined parameters (the 3D LUT file) at once by calling the color adjustment information at a desired timing has been proposed (also called “custom picture”).

Image capturing condition information (also called a “preset”) is also registered in advance. In the image capturing condition information, an image capturing range (e.g., the image capturing direction, the width of the angle of view, and the like) is associated with image capturing conditions (e.g., the exposure and image quality of the captured image, reference information for the color adjustment information, and the like). A function by which the user can then set the image capturing range and image capturing conditions at once by calling the image capturing condition information at a desired timing has been proposed. These functions can also be used in combination with each other.

A technique has been disclosed in which a user can select a combination of an image processing parameter set and a 3D LUT, and flexible image processing according to the user’s preferences is then provided (Japanese Patent Laid-Open No. 7129678). However, the custom picture file (color adjustment information) is managed independently from the preset. As such, changing at least some of the information in the custom picture file may affect the preset associated with that custom picture file.

On the other hand, a technique has been disclosed for avoiding the effects of conflict among a plurality of setting items that are in a dependency relationship in a situation where such conflict arises when inputting some of the settings (Japanese Patent Laid-Open No. 6494395).

If a user changes any of the color adjustment settings in a custom picture file to record a plurality of presets, the following situation may arise. For example, if reference information for the same custom picture file is recorded in a preset, the color adjustment settings for the custom picture file last set in the plurality of presets will be applied. In other words, the color adjustment settings are changed to different color adjustment settings than those first recorded in the preset. Furthermore, if a plurality of color adjustment settings and 3D LUT files are recorded for a preset managed independently from the custom picture file, a large recording space will be required.

### SUMMARY

Accordingly, the present disclosure provides a technique for recording a large amount of image capturing condition information in a smaller amount of recording space.

An information processing apparatus records, based on whether at least a predetermined parameter is included in color adjustment information recorded independently from image capturing condition information, a color adjustment setting of the color adjustment information or reference information of the color adjustment information in the image capturing condition information.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of the configuration of an image capturing system according to a first embodiment.

FIG. 2 is a diagram illustrating an example of the configuration of an image capturing apparatus according to the first embodiment.

FIG. 3 is a flowchart illustrating processing by which the image capturing apparatus records image capturing condition information, according to the first embodiment.

FIG. 4 is a flowchart illustrating processing executed by the image capturing apparatus based on the image capturing condition information, according to a second embodiment.

FIG. 5 is a diagram illustrating an example in which color adjustment settings are recorded in the image capturing condition information, according to the first embodiment.

FIG. 6 is a diagram illustrating an example in which reference information for color adjustment information is recorded in the image capturing condition information, according to the first embodiment.

FIG. 7 is a diagram illustrating processing executed when the image capturing condition information in FIG. 5 is executed, according to the second embodiment.

FIG. 8 is a diagram illustrating processing executed when the image capturing condition information in FIG. 6 is executed, according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Definitions of Terms

Although details will be given later, an image capturing apparatus 1 according to first and second embodiments has a function for setting an image capturing range and image capturing conditions (conditions related to the image quality of captured images) at once by calling, at a desired time, pre-registered image capturing condition information that associates the image capturing range and the image capturing conditions with each other. The pre-registered image capturing condition information will be called a “preset”.

Furthermore, the image capturing apparatus 1 according to the first and second embodiments has a function for setting color adjustment settings and a 3D LUT file at once by calling, at a time desired by a user, pre-registered color adjustment information that associates the color adjustment settings and the 3D LUT file with each other. The pre-registered color adjustment information will be called a “custom picture file”. The color adjustment settings will be called “custom picture parameters”. Finally, the 3D LUT file will be called a “Look file”.

### First Embodiment

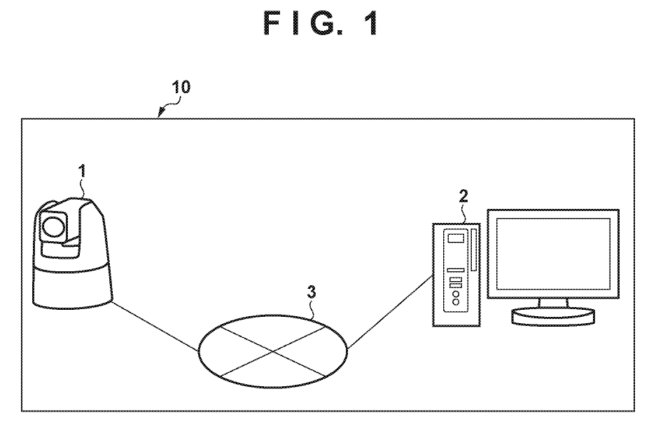

FIG. 1 is a diagram illustrating an example of the configuration of an image capturing system according to the first embodiment.

An image capturing system 10 is a remote camera system. “Remote camera system” refers to a system that enables a user to remotely operate a camera in real time. The image capturing system 10 includes at least the image capturing apparatus 1, a client apparatus 2, and a network 3. The image capturing apparatus 1 is a camera that captures an image of a subject, and is a remote camera, for example. The image capturing apparatus 1 and the client apparatus 2 are communicably connected to each other over the network 3. In one embodiment, the image capturing system 10 includes the image capturing apparatus 1 and the client apparatus 2, which controls the image capturing apparatus 1. Note that in the image capturing system 10, an information processing apparatus having some of the functions of the image capturing apparatus 1 (e.g., recording and executing presets) may be used instead of the image capturing apparatus 1. Such an information processing apparatus having some of the functions of the image capturing apparatus 1 may be installed in at least one of the image capturing apparatus 1 and the client apparatus 2.

The client apparatus 2 is an apparatus that controls the image capturing apparatus 1, and is an apparatus having a communication function, such as a personal computer (PC), for example. The client apparatus 2 sends control commands for controlling image capturing operations (also called “camera control commands” hereinafter) to the image capturing apparatus 1. Various operations of the image capturing apparatus 1 are controlled as a result (e.g., controlling the angle of view, including pan, tilt, and zoom; control of image quality of captured images; and the like).

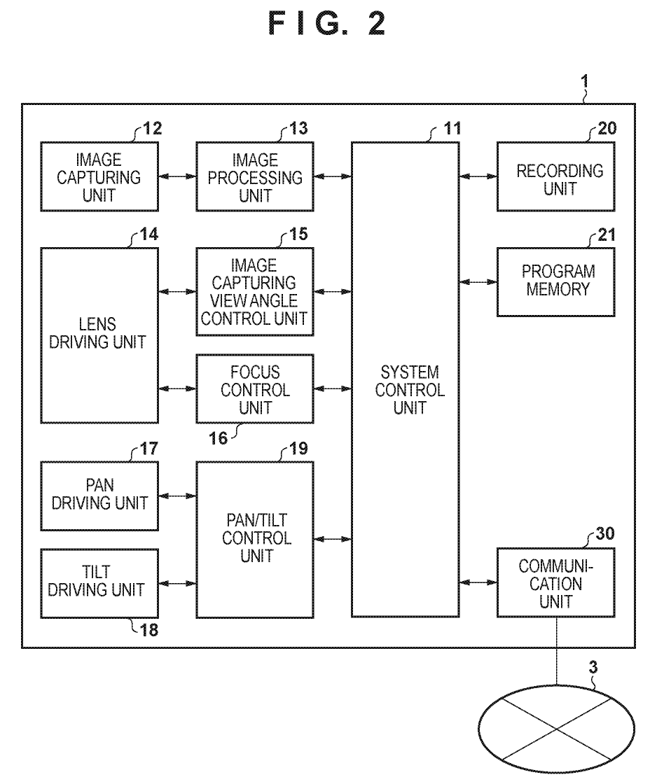

As mentioned above, the image capturing apparatus 1 is an image capturing apparatus such as a remote camera, for example. Using an image capturing unit 12 (described later; see FIG. 2), the image capturing apparatus 1 captures still images and moving images of a subject (these various images may also be called simply “images” hereinafter). The image capturing apparatus 1 also executes processing in accordance with the camera control commands sent from the client apparatus 2. The image capturing apparatus 1 sends information indicating results of executing the processing to the client apparatus 2 as responses.

FIG. 2 is a diagram illustrating an example of the configuration of the image capturing apparatus according to the first embodiment.

The image capturing apparatus 1 includes a system control unit 11, the image capturing unit 12, an image processing unit 13, a lens driving unit 14, an image capturing view angle control unit 15, a focus control unit 16, a pan driving unit 17, a tilt driving unit 18, and a pan/tilt control unit 19. The image capturing apparatus 1 further includes a recording unit 20, a program memory 21, and a communication unit 30.

The recording unit 20 records image data, the image capturing condition information (presets), the color adjustment information (custom picture files), and the like. The program memory 21 stores control programs. The communication unit 30 communicates with the client apparatus 2 over the network 3.

The recording unit 20 records various types of data (setting information indicating image capturing conditions such as the angle of view and image quality (parameters), image data of moving images and still images, and the like) in a recording device (internal storage, external storage, or the like (not shown)). The recording device (not shown) is a non-volatile memory such as a Flash memory, an Electrically Erasable Programmable Read-Only Memory (EEPROM), or the like, for example. The setting information (parameters) can be recorded in the recording device (non-volatile memory), for example.

The program memory 21 is a memory that stores a control program for controlling the operations of the image capturing apparatus 1 (also called a “camera control program” hereinafter). The program memory 21 is, for example, a read-only memory (ROM) or the like.

The system control unit 11 executes various types of processing based on the control programs recorded in the program memory 21. The system control unit 11 can be realized by a processor such as a central processing unit (CPU), for example.

The system control unit 11 controls the image capturing apparatus 1 as a whole. The system control unit 11 instructs the various constituent elements illustrated in FIG. 2 (the image capturing unit 12 to the communication unit 30) to perform various types of processing. The system control unit 11 also analyzes camera control commands received from the client apparatus 2 through the communication unit 30. The system control unit 11 executes processing based on the results of analyzing the camera control commands.

The camera control commands include at least a view angle control command, an image quality control command, and a request command, for example. The view angle control command is a command that controls the pan, tilt, zoom, and the like of the image capturing apparatus 1. The image quality control command is a command that controls image capturing conditions related to image quality, such as gamma, a color matrix, and the like. The request command is a command that requests the image capturing apparatus 1 to send image data, setting values, and the like.

When the client apparatus 2 requests image data to be sent, the system control unit 11 sends image data generated by the image processing unit 13 to the client apparatus 2 through the communication unit 30.

The system control unit 11 may also receive, from the client apparatus 2, a request command requesting the image capturing apparatus b to send setting values such as zoom, focus, pan/tilt, and the like. In this case, the system control unit 11 obtains the setting values from the image processing unit 13, the image capturing view angle control unit 15, the focus control unit 16, and the pan/tilt control unit 19. The system control unit 11 then sends the setting values to the client apparatus 2 through the communication unit 30. Note that the setting values can include not only current setting values, but also information related to the setting values (e.g., a range of setting values that can be set in the image capturing apparatus 1).

The system control unit 11 may receive, from the client apparatus 2, a view angle control command requesting the setting of pan, tilt, zoom, and focus (also called “PTZF”) in the image capturing apparatus 1. In this case, the system control unit 11 controls the image processing unit 13, the image capturing view angle control unit 15, the focus control unit 16, and the pan/tilt control unit 19 based on the setting values in the view angle control command. The image processing unit 13, the image capturing view angle control unit 15, the focus control unit 16, and the pan/tilt control unit 19 then control the operations of the image capturing unit 12, the lens driving unit 14, the pan driving unit 17, and the tilt driving unit 18, respectively. As a result, the various constituent elements of the image capturing apparatus 1 are controlled based on the zoom, focus, and pan/tilt setting values sent from the client apparatus 2.

The system control unit 11 may receive, from the client apparatus 2, an image quality control command for setting gamma and the like. In this case, the system control unit 11 controls the operations of the image processing unit 13 based on the setting values in the image quality control command. The image processing unit 13 then controls the operations of the image capturing unit 12. As a result, the various constituent elements of the image capturing apparatus 1 are controlled based on the setting values such as gamma sent from the client apparatus 2.

The image capturing unit 12 includes optical elements such as lenses (e.g., a focus lens and a zoom lens) and an image sensor. The image capturing unit 12 converts the result of capturing an image of a subject into an electrical signal. The image sensor is an image sensor such as a Complementary Metal-Oxide-Semiconductor (CMOS) or a Charge-Coupled Device (CCD), for example.

The image processing unit 13 executes predetermined image processing, resolution conversion processing, compression/encoding processing, and the like on the electrical signal obtained through the photoelectric conversion by the image capturing unit 12, and generates image data of still images and moving images. The image processing unit 13 can be implemented by a CPU, a graphics processing unit (GPU), or the like, for example. The communication unit 30 sends the image data generated by the image processing unit 13 to the client apparatus 2 over the network 3.

The lens driving unit 14 includes driving systems for the focus lens and the zoom lens of the image capturing unit 12, as well as motors for the drive sources thereof. The operations of the lens driving unit 14 are controlled by the image capturing view angle control unit 15 and the focus control unit 16.

The image capturing view angle control unit 15 instructs the lens driving unit 14 to change the zoom lens position based on a zoom setting value instructed by the system control unit 11. Here, for example, the image capturing view angle control unit 15 manages the focal length as the zoom setting value.

The focus control unit 16 instructs the lens driving unit 14 to change the focus lens position based on a focus setting value instructed by the system control unit 11. The position of the focus lens is changed by the driving by the lens driving unit 14. The focus position is changed as a result.

The pan driving unit 17 includes a mechanical driving system that performs pan operations, and a motor for a drive source. The pan driving unit 17 performs pan operations based on instructions from the pan/tilt control unit 19.

The tilt driving unit 18 includes a mechanical driving system that performs tilt operations, and a motor for a drive source. The tilt driving unit 18 performs tilt operations based on instructions from the pan/tilt control unit 19.

The pan/tilt control unit 19 controls the operations of at least one of the pan driving unit 17 and the tilt driving unit 18 based on the pan and tilt setting values instructed by the system control unit 11. At least one of the pan and the tilt is changed as a result.

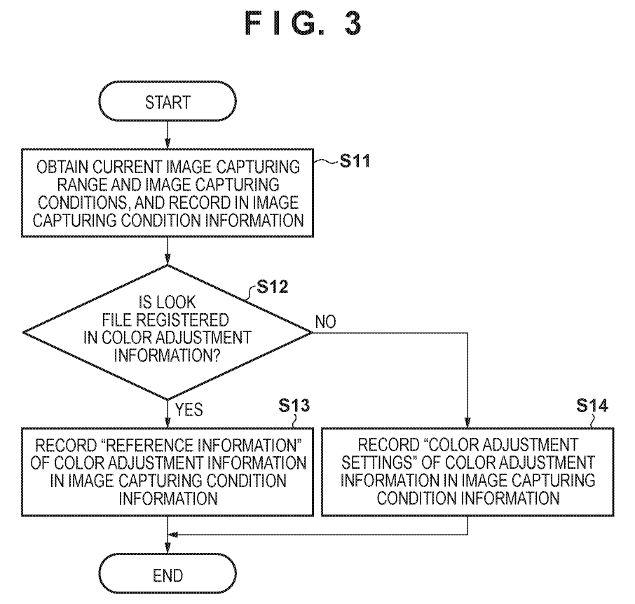

FIG. 3 is a flowchart illustrating processing by which the image capturing apparatus records image capturing condition information, according to the first embodiment. The processing in FIG. 3 is realized by the CPU of the system control unit 11 executing a control program recorded in the program memory 21 (ROM).

In the image capturing system 10, a user can pre-register image capturing conditions related to the exposure and the image quality of captured images. The user can also pre-register the image capturing condition information (the preset) associating the image capturing conditions and an image capturing range with each other. The user can change the setting values of the image capturing apparatus 1 based on the preset by calling the image capturing condition information (the preset) at a desired time.

FIG. 3 illustrates an example in which the image capturing apparatus 1 executes preset recording processing based on a preset recording instruction made by the user. The processing illustrated in FIG. 3 is started, for example, when a recording instruction for the image capturing condition information (the preset) is sent to the image capturing apparatus 1 based on a user operation made through the client apparatus 2. For example, the user sends the recording instruction for the image capturing condition information (the preset) to the image capturing apparatus 1 through the client apparatus 2. In this case, the client apparatus 2 sends a camera control command to the image capturing apparatus 1.

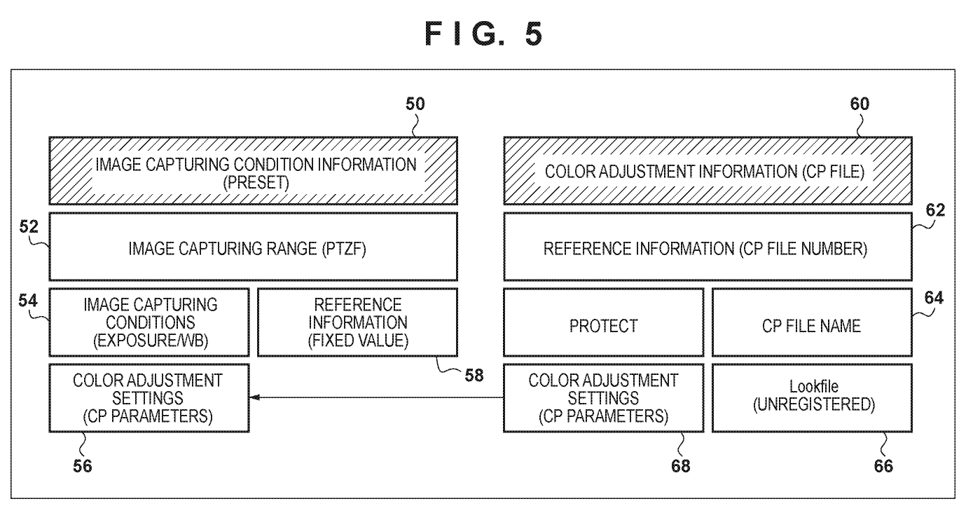

FIG. 5 is a diagram illustrating an example in which color adjustment settings are recorded in the image capturing condition information, according to the first embodiment. FIG. 5 illustrates a relationship between image capturing condition information 50 and color adjustment information 60 after the processing of step S14 in FIG. 3 is complete.

The image capturing condition information 50 (the preset) includes an image capturing range 52 (e.g., pan, tilt, zoom, and focus), image capturing conditions 54 (e.g., exposure and white balance (WB)), color adjustment settings 56 (e.g., custom picture parameters), and reference information 58 (e.g., a custom picture file number (fixed value)). Here, the “reference information 58 (fixed value)” refers to reference information for the color adjustment information associated with the recording of the color adjustment settings 56. It should also be noted that the color adjustment settings 56 are present after the processing of step S14 in FIG. 3 is complete.

On the other hand, the color adjustment information 60 (the custom picture file) includes reference information 62 (a custom picture file number), a custom picture file name 64, a Look file 66 (unregistered), which is predetermined parameters, and color adjustment settings 68 (custom picture parameters). Here, “Look file 66 (unregistered)” means that the Look file 66 is not registered in the color adjustment information 60.

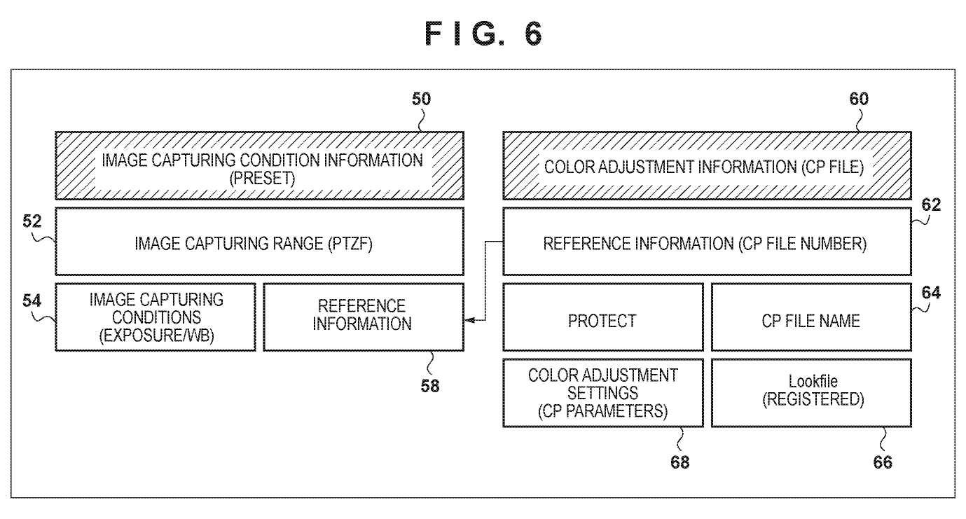

FIG. 6 is a diagram illustrating an example in which the reference information for the color adjustment information is recorded in the image capturing condition information, according to the first embodiment. FIG. 6 illustrates a relationship between the image capturing condition information 50 and the color adjustment information 60 after the processing of step S13 in FIG. 3 is complete.

The image capturing condition information 50 (the preset) includes the image capturing range 52 (e.g., pan, tilt, zoom, and focus), the image capturing conditions 54 (e.g., exposure and white balance (WB)), and the reference information 58 (e.g., a custom picture file number).

On the other hand, the color adjustment information 60 (the custom picture file) includes the reference information 62 (a custom picture file number), the custom picture file name 64, a Look file 66 (registered), which is predetermined parameters, and the color adjustment settings 68 (custom picture parameters). Here, “Look file 66 (registered)” means that the Look file 66 is registered in the color adjustment information 60. The processing illustrated in FIG. 3 will be described hereinafter with reference to FIGS. 5 and 6.

In step S11, the system control unit 11 obtains the image capturing conditions 54 and the image capturing range 52 by analyzing the camera control command, and records the image capturing conditions 54 and the image capturing range 52 in the image capturing condition information 50 in the recording unit 20. Note that the image capturing condition information 50 includes setting values for a plurality of the image capturing conditions 54, including at least image capturing conditions related to the image quality of the captured image, and two or more setting targets.

In step S12, the system control unit 11 specifies the color adjustment information 60 based on the reference information 58 in the image capturing condition information 50 obtained in step S11, and determines whether the Look file 66 (the predetermined parameters) is recorded in the color adjustment information 60.

If the Look file 66 (the predetermined parameters) is determined to be recorded in the color adjustment information 60 (Yes in step S12), the system control unit 11 moves the sequence to step S13. However, if the Look file 66 (the predetermined parameters) is determined not to be recorded in the color adjustment information 60 (No in step S12), the system control unit 11 moves the sequence to step S14.

In step S13, the system control unit 11 records the reference information 62 in the image capturing condition information 50 in the recording unit 20 (see FIG. 6). When the recording of the image capturing condition information 50 is complete, the system control unit 11 ends the sequence.

In step S14, the system control unit 11 records the color adjustment settings 68 in the image capturing condition information 50 in the recording unit 20 (see FIG. 5). When the recording of the image capturing condition information 50 is complete, the system control unit 11 ends the sequence.

As described thus far, the image capturing apparatus 1 can determine the information to be recorded in the image capturing condition information 50 based on whether at least the Look file 66 (the predetermined parameters) is recorded in the color adjustment information 60, which is recorded independently from the image capturing condition information 50. As a result, the image capturing apparatus 1 can record the color adjustment settings 56 in the image capturing condition information 50 independently from the color adjustment settings 68 of the color adjustment information 60. In other words, more types of the image capturing condition information 50 can be stored in less recording space. Furthermore, in a situation where the user has edited the color adjustment information 60 after the recording of the image capturing condition information 50 is complete, this makes it possible to avoid adversely affecting the image capturing condition information 50 that references the edited color adjustment information 60.

### Variation 1: User Input

Note that the system control unit 11 can present the user interface described hereinafter to the user when the user operates the client apparatus 2 to instruct the image capturing condition information 50 to be recorded. The user interface includes, for example, an item for instructing the reference information 62 of the color adjustment information 60 to be recorded in the image capturing condition information 50, and an item for instructing the color adjustment settings 68 of the color adjustment information 60 to be recorded in the image capturing condition information 50. By selecting one of the instruction items displayed in the user interface, the user can instruct the image capturing apparatus 1 to record the corresponding information in the image capturing condition information 50. In one embodiment, the image capturing apparatus 1 can record the color adjustment settings 68 or the reference information 62 in the image capturing condition information 50 based on a user input made through the user interface. Here, the user input is an input for recording the color adjustment settings 68 or the reference information 62 in the image capturing condition information 50.

### Variation 2: Modes

The system control unit 11 can also determine the information to be recorded in the image capturing condition information 50 based on, for example, a mode in which the user makes an additional input when instructing the image capturing condition information 50 to be recorded. The mode is a mode related to the recording of the image capturing condition information 50. For example, the mode includes a mode for recording the reference information 62 of the color adjustment information 60 in the image capturing condition information 50, and a mode for recording the color adjustment settings 68 of the color adjustment information 60 in the image capturing condition information 50. In one embodiment, the system control unit 11 can record the color adjustment settings 68 or the reference information 62 in the image capturing condition information 50 based on the mode selected by the user. Although the system control unit 11 continues to execute processing based on the mode selected by the user until the mode selected by the user is changed or canceled, the configuration is not limited thereto. For example, the selected mode may be automatically canceled after a certain length of time has passed.

### Second Embodiment

In the first embodiment, when the user instructs the image capturing condition information 50 to be recorded, the image capturing apparatus 1 determines the information to be recorded in the image capturing condition information 50 in accordance with the registration state of the Look file 66 (the predetermined parameters) in the color adjustment information 60. A second embodiment will describe an example in which the settings are changed at once based on the information recorded in the image capturing condition information 50 (the color adjustment settings 68 obtained from the image capturing range 52, the image capturing conditions 54, the color adjustment settings 56, or the reference information 58 (fixed value)). The second embodiment will describe differences from the first embodiment.

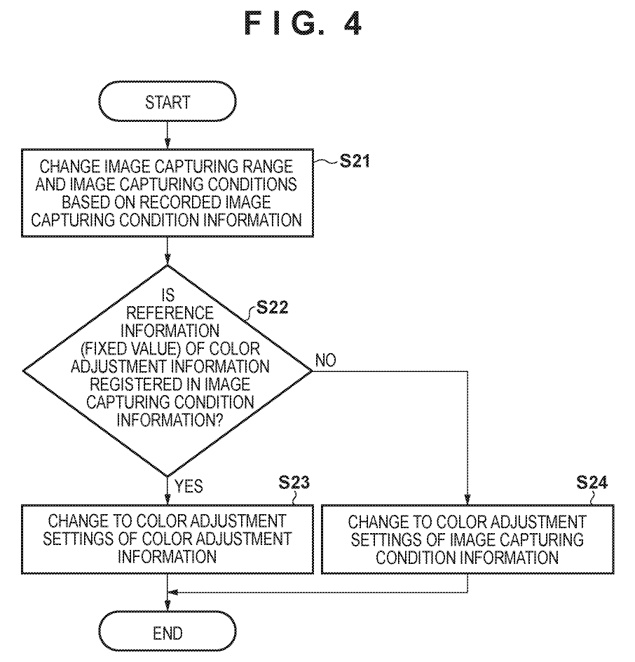

FIG. 4 is a flowchart illustrating processing executed by the image capturing apparatus based on the image capturing condition information, according to the second embodiment. Processing for changing the settings of the image capturing apparatus 1 in accordance with the information recorded in the image capturing condition information 50 will be described in particular. The processing in FIG. 4 is realized by the CPU of the system control unit 11 executing a control program recorded in the program memory 21 (ROM).

The processing illustrated in FIG. 4 is started, for example, when the user instructs the image capturing apparatus 1 to execute the image capturing condition information 50 through the client apparatus 2.

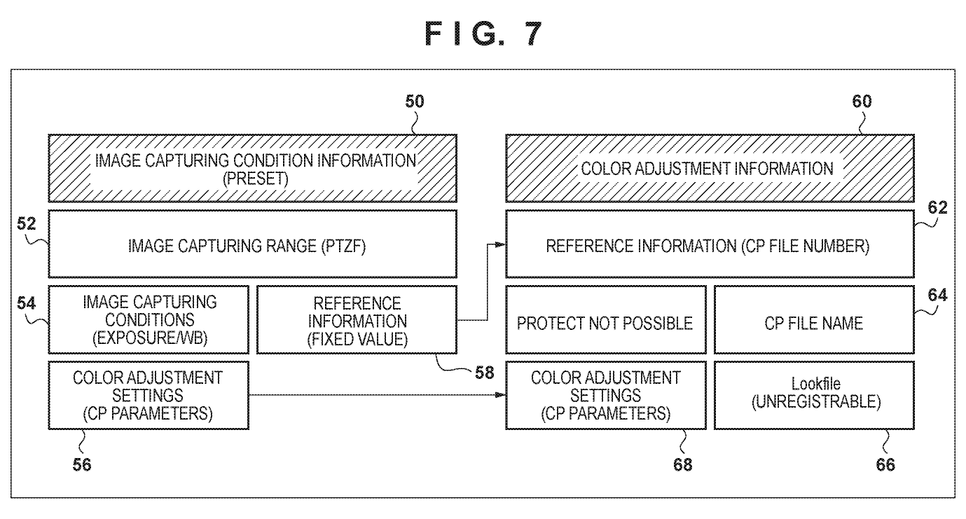

FIG. 7 is a diagram illustrating processing executed when the image capturing condition information in FIG. 5 is executed, according to the second embodiment.

The image capturing condition information 50 (the preset) includes an image capturing range 52 (e.g., pan, tilt, zoom, and focus), image capturing conditions 54 (e.g., exposure and white balance (WB)), color adjustment settings 56 (e.g., custom picture parameters), and reference information 58 (e.g., a custom picture file number (fixed value)). Here, as described with reference to FIG. 5, the “reference information 58 (fixed value)” refers to reference information for the color adjustment information associated with the recording of the color adjustment settings 56.

On the other hand, the color adjustment information 60 (the custom picture file) includes the reference information 62 (the custom picture file number), the custom picture file name 64, a Look file 66 (unregistrable), which is predetermined parameters, and the color adjustment settings 68 (custom picture parameters). Here, “Look file 66 (unregistrable)” means that the user is unable to edit (register) the Look file 66 (in other words, an unregistrable state). The color adjustment settings 68 also indicate that the system control unit 11 has set the color adjustment settings 56 of the image capturing condition information 50 in the color adjustment information 60.

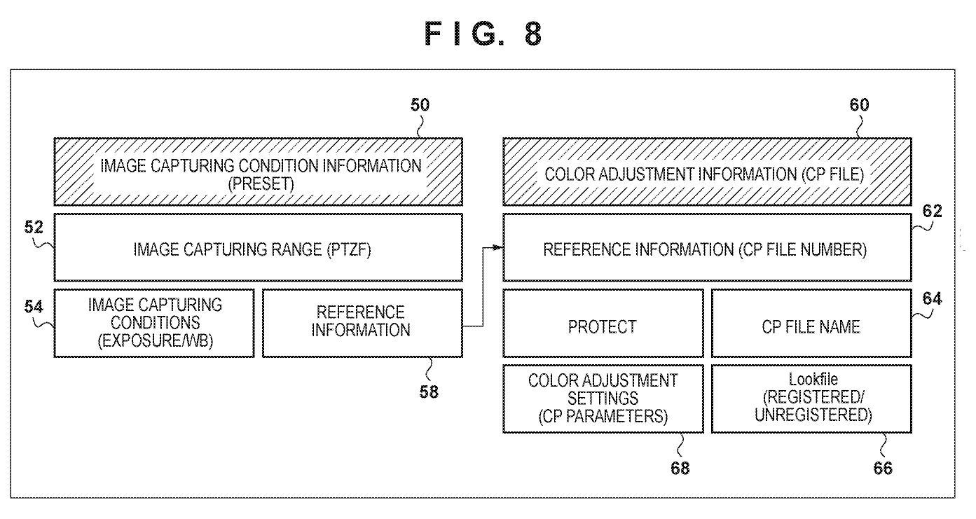

FIG. 8 is a diagram illustrating processing executed when the image capturing condition information in FIG. 6 is executed, according to the second embodiment.

The image capturing condition information 50 (the preset) includes the image capturing range 52 (e.g., pan, tilt, zoom, and focus), the image capturing conditions 54 (e.g., exposure and white balance (WB)), and the reference information 58 (a custom picture file number).

On the other hand, the color adjustment information 60 (the custom picture file) includes the reference information 62 (the custom picture file number), the custom picture file name 64, a Look file 66 (registered or unregistered), and the color adjustment settings 68 (custom picture parameters). Here, “Look file 66 (registered or unregistered)” means that the Look file 66 is registered or is not registered in the color adjustment information 60. Even if the user has registered the Look file 66 in the color adjustment information 60 after the image capturing condition information 50 has been recorded, the color adjustment information 60 can be called based on the reference information 58, and there are thus no particular adverse effects when the image capturing condition information 50 is executed. As such, the Look file 66 may be in either a “registered” or an “unregistered” state. The processing illustrated in FIG. 4 will be described hereinafter with reference to FIGS. 7 and 8.

In step S21, the system control unit 11 obtains the image capturing range 52 and the image capturing conditions 54 from the recording unit 20 based on an instruction to execute the image capturing condition information 50 from the client apparatus 2. The system control unit 11 controls the various constituent elements of the image capturing apparatus 1 based on the image capturing condition information 50, and applies the image capturing range 52 and the image capturing conditions 54 at once.

In step S22, the system control unit 11 determines whether the reference information 58 (fixed value) of the color adjustment information 60 is registered in the image capturing condition information 50 from step S21. Herein, the reference information 58 (fixed value) will also be referred to as “specific reference information”.

If the reference information 58 (fixed value) of the color adjustment information 60 is determined to be registered (Yes in step S22), the system control unit 11 moves the sequence to step S23. However, if the reference information 58 of the color adjustment information 60 is determined not to be registered (No in step S22), the system control unit 11 moves the sequence to step S24.

In step S23, the system control unit 11 calls the color adjustment information 60 from the reference information 58 (see FIG. 8) registered in the image capturing condition information 50 in step S21. The system control unit 11 then applies the color adjustment settings 68 and the Look file 66 (registered/unregistered) of the color adjustment information 60 at once. Once the change in settings is complete, the system control unit 11 ends the sequence. In this manner, the system control unit 11 can execute the image capturing condition information 50 including the image capturing conditions 54 and the image capturing range 52 using the color adjustment settings 68 of the color adjustment information 60 specified from the reference information 58 registered in the image capturing condition information 50 (see FIG. 8), and the various settings can be applied at once.

In step S24, the system control unit 11 obtains the color adjustment settings 56 from the image capturing condition information 50 from step S21 (see FIG. 7). The system control unit 11 then controls the various constituent elements of the image capturing apparatus 1 based on the color adjustment settings 56. Once the change to the color adjustment settings 56 is complete, the system control unit 11 ends the sequence. In this manner, the system control unit 11 can execute the image capturing condition information 50 including the color adjustment settings 56, the image capturing conditions 54, and the image capturing range 52 related to the specific reference information 58 (fixed value), and the various settings can be applied at once.

As described thus far, the image capturing apparatus 1 can apply the color adjustment settings 68 of the color adjustment information 60 or the color adjustment settings 56 of the image capturing condition information 50 based on whether the reference information 58 is recorded in the image capturing condition information 50. The color adjustment settings 56 of the image capturing condition information 50 can therefore be executed independently from the color adjustment settings 68 of the color adjustment information 60. This enables a large amount of image capturing condition information 50 to be recorded in a smaller recording space, and the various settings of the image capturing apparatus 1 can be changed at once by executing the image capturing condition information 50.

Note that the system control unit 11 can control the registration (recording) of the Look file 66 (illustrated in FIG. 7) to be in a disabled state in the color adjustment information 60 when the color adjustment settings 56 of the image capturing condition information 50 are applied in step S24. The color adjustment settings 56 of the image capturing condition information 50 are color adjustment settings related to the specific reference information 58. This makes it possible to prevent the occurrence of a combination of the color adjustment settings 68 and the Look file 66 in which the Look file 66 cannot be enabled. Color adjustment information 66 (FIG. 7) in which the registration of the Look file 66 is always in a disabled state may also be prepared in the color adjustment information 60 in order to apply the color adjustment settings 56 of the image capturing condition information 50. In this case, the system control unit 11 may set the color adjustment settings 56 of the image capturing condition information 50 in the color adjustment information 66 (FIG. 7). As a result, the color adjustment settings 68 illustrated in FIG. 7 are registered in the color adjustment information 60.

Although embodiments of the present disclosure have been described above, the technical spirit of the present disclosure is not intended to be limited to these embodiments, and many variations and alterations are possible within the scope thereof. Additionally, the embodiments of the present disclosure can also be carried out as a system, an apparatus, a method, a program, a recording medium, or the like. According to the present disclosure, a large amount of image capturing condition information can be recorded in a smaller recording space.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus comprising:
one or more memories storing instructions; and
one or more processors executing the instructions to:
record, based on whether at least a predetermined parameter is included in color adjustment information recorded independently from image capturing condition information, a color adjustment setting of the color adjustment information or reference information of the color adjustment information in the image capturing condition information.

2. The information processing apparatus according to claim 1,
wherein, in a case where the predetermined parameter is included in the color adjustment information, the recording is performed by recording the reference information in the image capturing condition information.

3. The information processing apparatus according to claim 1,
wherein, in a case where the predetermined parameter is not included in the color adjustment information, the recording is performed by recording the color adjustment setting in the image capturing condition information.

4. The information processing apparatus according to claim 1,
wherein the recording is performed by recording the color adjustment setting or the reference information in the image capturing condition information based on a user input, and
wherein the user input is an input for recording the color adjustment setting or the reference information in the image capturing condition information.

5. The information processing apparatus according to claim 1,
wherein the recording is performed by recording the color adjustment setting or the reference information in the image capturing condition information based on a mode related to recording of the image capturing condition information, and
wherein the mode is a mode in which the color adjustment setting is recorded in the image capturing condition information or a mode in which the reference information is recorded in the image capturing condition information.

6. The information processing apparatus according to claim 1,
wherein the one or more processors further execute the instructions to perform control to execute the image capturing condition information,
wherein, in a case where specific reference information of the color adjustment information is included in the image capturing condition information, the control is executed to disable recording of the predetermined parameter in the color adjustment information, and
wherein the image capturing condition information includes a color adjustment setting, an image capturing condition, and an image capturing range related to the specific reference information.

7. The information processing apparatus according to claim 6,
wherein, in a case where the specific reference information is not included in the image capturing condition information, in the control, the image capturing condition information is executed using a color adjustment setting specified by the reference information of the color adjustment information, and
wherein the image capturing condition information includes the image capturing condition and the image capturing range.

8. The information processing apparatus according to claim 1,
wherein the predetermined parameter is a 3D LUT.

9. The information processing apparatus according to claim 1, further comprising:
an image capturing device.

10. An image capturing system comprising:
an information processing apparatus including:
an image capturing device, and
one or more processors configured to record, based on whether at least a predetermined parameter is included in color adjustment information recorded independently from image capturing condition information, a color adjustment setting of the color adjustment information or reference information of the color adjustment information in the image capturing condition information; and
a client apparatus configured to control the image capturing device.

11. A method executed by an information processing apparatus, the method comprising:
recording, based on whether at least a predetermined parameter is included in color adjustment information recorded independently from image capturing condition information, a color adjustment setting of the color adjustment information or reference information of the color adjustment information in the image capturing condition information.
